(19) United States
(12) Patent Application Publication
(10) Pub. No.: US 2013/0045468 A1
(43) Pub. Date: Feb. 21, 2013

(54) Personal Hygiene System for Developmentally Disabled Individuals

(71) Applicants: Paul Wulf, Kissimmee, FL (US); Debra Wulf, Kissimmee, FL (US)

(72) Inventors: Paul Wulf, Kissimmee, FL (US); Debra Wulf, Kissimmee, FL (US)

(21) Appl. No.: 13/214,173

(22) Filed: Aug. 20, 2011

(51) Int. Cl. G09B 19/00

(52) U.S. Cl. 434/247

(57) ABSTRACT

A method and system for training and teaching developmentally disabled individual's proper and effective basic personal hygiene techniques. The method is comprised of developmentally level appropriate pre-recorded audible messages leading specifically challenged participants through comprehensive step-by-step instructions that require no retention or anticipated advancement. It also includes predetermined, measured pauses that optimally facilitate the individual's

### BACKGROUND OF THE INVENTION

1. Field of the Invention

This invention generally relates to systems and methods for instructing and improving personal hygiene, and in particular for that instruction to be uniquely created and specifically tailored to address the inability of special needs participants to comprehend directions as would be ordinarily anticipated and the inability of their performance capacity to undergo any measurable advancement or even demonstrate the ability to adapt, improve, process, respond or grow. The differences needed for instruction and care of developmentally disabled individuals is exhaustive. If it were obvious to a person of ordinary skill to adapt or otherwise alter existing teaching techniques and methods there would be no need for special classrooms, special books, special teachers, special environments, or even Special Olympics. In each case it is an example of pre-determined programming which addresses the chronically compromised ability to retain, absorb, grasp, recall and process basic directions and communications whereby development and progress toward independent proficiency is not a matter of adapting or adopting methods and programs used by non-developmentally challenged participants. Personal hygiene is another area that requires those same differences in concept, delivery and programming that is not merely an attempt to adapt, modify or assimilate programs used by other participants of the general population who exhibit the capacity to advance and progress in the performance of these tasks as is ordinarily anticipated with other instructional models and methods.

2. Description of the Related Art

Learning, retaining and utilizing proper techniques of basic personal hygiene is one of the processes of a “normal” child's development. As an infant, the child is completely dependent on a parent or caregiver to perform these tasks for them. As they age and grow they develop the necessary cognitive abilities, manual dexterity and physical motor skills that allow them to perform these tasks on their own, independent of any further or continued assistance. For those whose “normal” development was impeded for some reason they would rely on continued dependence upon a parent or caregiver for ongoing tutelage in these areas. The problem is that parents and caregivers are constantly battling against the lack of understanding regarding instructions. Parents and caregivers routinely use different words and terms in an effort to improve responses to directions which has the opposite effect. The confusion in these cases is that with the impeded development, the instructions are not a different way to express the same task but a different task entirely.

The prior art addressing hygiene relies on adapting or modifying an existing product for use by individuals with special needs. The problem exists with hygiene instruction as it does with the other areas of involvement with special needs; it requires specifically designed or engineered programming for developmentally challenged individuals to participate as it isn't merely a matter of design choice or adaptation to anyone of ordinary skill in the art. This is prevalent throughout the types of hygiene products currently available for caregivers and developmentally normal children. The first type of product offers instruction and reinforcement to the child participants while they are executing the particular hygiene tasks. One example of such a system is U.S. Pat. No. 6,037,871 to Babylon; this system includes a various sensors throughout the bathroom and on various fixtures like the toilet, a bench that steps up to the toilet, the wash basin, sink and soap dish. These sensors detect movement and initiate a playback of encouragement on the current bathroom task and a reminder of what is the next task as in a handle depressed on the toilet signaling the completion of that phase of use initiates a playback device that compliments the participant on that step and a reminder to wash next.

Another type of product offers feedback or additional instruction after a participant has completed a hygiene task. An example of this type of product is

U.S. Pat. Publication No. 2005/0239029 A1 to Yzermans et al.; this system includes the use of a prerecorded message for toilet training whereby a participant can use a phone or internet to gain access to this message which can be used by either a caregiver or participant. There can be several messages used for a single hygiene task as in the case of toilet training and additional embodiments can include apparel with illustrations associated with the prerecorded messages regarding a single or multiple hygiene tasks.

Another type of product offers instructions to a caregiver or adult with directions on how to instruct a young participant through good habits and activities. An example of this type of product is U.S. Pat. Publication No. 2004/0018474 to D'Ippolito; this system includes directions for an adult to convey life experiences and habits to a child. The system includes exercises and activities for the participant and supervised by the adult with workbooks, videos, prerecorded messages and computer software. U.S. Pat. No. 6,250,929 to Kolb provides a method for improving the effectiveness of toilet training using a progress scale with questions regarding toilet training learned skills with response values to evaluate levels of toilet training with recommendations for improving the effectiveness of the training based on the skill. U.S. Pat. No. 6,203,327 to Ottrando shows a toilet training system using a board with a pre-printed path made up of step spaces and reward goal spaces with removable marks made on the board to indicate progress for each mark and setbacks by removing marks. U.S. Pat. No. 5,725,382 to Walter claims a self-contained interactive toilet training kit for children and caregivers that includes training pants, interactive devices and activity devices for encouraging the child in toilet training. U.S. Pat. No. 5,387,107 to Gunter describes a personalized interactive storybook and method of teaching a reader a desired behavior pattern with text referring to the desired behavior and illustrations, which may be modified to include a picture of the child, related to the carrying out of the desired behavior. U.S. Pat. No. 2,946,137 to Worth discloses a child's story book with shift-able pictures using cut-out stickers that a child can place in different positions and on different pages in the book. U.S. Pat. No. 5,577,915 to Feldman indicates a motivational task tracking device that organizes activities into categories and provides a graphic incentive system for their performance with cards representing activities placed on a chart to indicate progress. U.S. Pat. No. 5,951,298 to Werzberger puts forth an interactive coordinated book assembly with pages having instructions for activities with a key word or image related to the life experiences and good habits and activities and knowledge and using a visual image associated with each activity and a code to indicate age of competency level.

Then there are systems and methods that have been developed to assist with learning disabilities. For example, U.S. Pat. No. 4,695,257 to Vawter; U.S. Pat. No. 5,336,093 to Cox; U.S. Pat. No. 5,135,398 to Thornton et al.; U.S. Pat. No. 5,256,067 to Gildea et al.; and U.S. Pat. No. 5,316,485 to Hirose are examples of such systems. These systems and methods are intended to assist in teaching reading, writing, and mathematics, not hygiene or the activities of daily living. A typical approach with these types of systems and methods is to incorporate conventional classroom techniques into a game or a computer program. These conventional teaching methods have already proven to be ineffective in reaching individuals with developmental disabilities.

As evidenced by the preceding paragraphs there are numerous products available to assist caregivers and children in the development of personal hygiene habits ranging from training guides to instructional materials. As the participants in these programs develop proficiency to perform these tasks they begin to exhibit autonomy and an independence from continued support and assistance from the program by design. In previously known products the design and functionality of the system is intended to foster, encourage and develop incremental improvement and eventual progression to independent functioning apart from continued product use. There is no design element in these products that is based on evaluations regarding the ability of the participant to progress or advance; the appropriateness of the instructions as it relates to someone of lower cognitive reasoning, understanding and recognition of common objects, terms or directions. Without significant study, development and redesign of these systems they have little value to someone with compromised reasoning capacity. The significant differences of capacity, functioning capability, cognitive reasoning, potential for cognitive retention and performance enhancement renders any adaptation or modification of existing products, systems or methods as an obvious matter of design choice by a person of ordinary skill in the art a serious lack of understanding regarding the unique and appropriate manner someone impacted by a developmental disability requires.

Therefore, a need exists for a product, system and method that is both appropriate and effective as a design intention that the participant has no prior knowledge of what the various hygiene devices or implements are; that the participant will not remember what those devices or implements are after being told; and will not retain any information regarding what those devices or implements are or what they are for after being instructed repeatedly about their use. A need exists for the elemental sequence of usage necessary for a developmentally disabled participant to be able maneuver through a specific set of directions so basic and comprehensive in nature that by its very obviousness to someone of ordinary skill in the art that it would not be practical as a tutorial or teaching aid. By its redundant nature it would serve no purpose to a “normal” participant in addition to the detailed rudimentary level at which it would need to be developed and its interminable amount of meticulous instruction. There can be no recognition of success or progress, no feedback on a correctly performed task and no advancement demonstrating any ability to use the products or to perform the tasks independently instead of relying on an adult, parent or caregiver to observe and confirm that the participant is performing the hygiene tasks adequately.

### SUMMARY

In one aspect, this invention is directed to a system and method for teaching and instructing special need's participants through various hygiene tasks. This method includes the use of prerecorded messages that instructs the participant through hygiene tasks based on the appropriateness of the directions and the duration of time allotted for the participant to complete the individual steps of the task before proceeding. It differs from any prior invention in that the directions are extremely rudimentary for ease of understanding of the supposed participants and the order of instruction and duration of time between steps has been predetermined to accommodate a participant who will not advance in proficiency nor retain and anticipate directions with further or continued use. It should be obvious and established in society that instruction, understanding and teaching techniques involving and affecting anyone with a developmental disability must be significantly changed and specifically oriented to have any hope of efficacy within the special needs population compared to similar offerings to “normal” developmentally enabled individuals.

In another aspect, this invention is directed and designed to address the lack of ability on the part of a developmentally disabled participant to share a similar tutorial dedicated to improving hygiene as used by someone of ordinary motor skills or reasoning capabilities. It is engineered to not only appeal to someone of diminished capacity but to be of use in its concept and presentation of the directions, explanations and definitions to: stimulate a predetermined response or at least a response within an anticipated range of acceptable behavior regarding a specific step within a given hygiene task; to allow variance in the response that a participant has the ability to produce; to insure adequate pause between steps so that a participant of limited means or diminished capacity is able to continue in sequence through the entire hygiene program; to accommodate various conditions outside normal parameters of functioning that allow a participant with developmental challenges to complete the task within an acceptable degree of effectiveness. It is a primary approach requiring highly detailed direction that transpires in an extremely smaller graduated rate than what would be expected or anticipated by someone of merely ordinary skill who is not intimately acquainted with the particular obstacles, challenges and hindrances encountered by a special needs participant.

In another aspect, this invention is directed to include an animated video modeling component to assist developmentally challenged participants by providing an example that can be imitated when the various hygiene tasks are to be attempted. The modeling feature is designed to help guide the participants by providing a visual depiction of the instructions and definitions contained in the instructions; by utilizing an animated character that helps to hold interest and engage the participant. As already indicated it is anticipated that the target participant in this invention will not progress or advance in the use or proficiency regarding the steps necessary to complete each hygiene task. It is therefore needed to demonstrate in a repetitive fashion the meaning, expectation and desired outcome with each of the instructions given for a particular phase of each hygiene task. Although the method does not depend on the participant retaining or anticipating the instruction, it is the desired outcome of the invention that the precepts and definitions of the terms and phrases in the prerecorded messages would elicit a specific response within certain identifiable parameters. These parameters are what the video modeling component establishes with the targeted participants. It is the conditioned response to the identical stimuli from the prerecorded messages used in the audio portion of the method and the visual portion which allows a participant to function within a range of desired and programmed responses.

### BRIEF DESCRIPTION OF THE DRAWINGS

FIG. 1 is an illustration of a programming initiative instructing the participant with a specially crafted vocabulary of suitable comprehension using a series of prerecorded messages to wash their face prompting a performance response from the participant. It is also a perspective of the visual interpretation from a visual demonstration of that sequential step in the hygiene task of taking a bath from the animated video modeling which presents the physical responses that correspond to the verbal prompts of the hygiene task.

FIG. 2 is an illustration of a programming initiative instructing the participant with a specially crafted vocabulary of suitable comprehension using a series of prerecorded messages to wash their hair prompting a performance response from the participant. It is also a perspective of the visual interpretation from a visual demonstration of that sequential step in the hygiene task of taking a bath from the animated video modeling which presents the physical responses that correspond to the verbal prompts of the hygiene task.

FIG. 3 is an illustration of a programming initiative instructing the participant with a specially crafted vocabulary of suitable comprehension using a series of prerecorded messages to wash their chest and shoulders prompting a performance response from the participant. It is also a perspective of the visual interpretation from a visual demonstration of that sequential step in the hygiene task of taking a bath from the animated video modeling which presents the physical responses that correspond to the verbal prompts of the hygiene task.

FIG. 4 is an illustration of a programming initiative instructing the participant with a specially crafted vocabulary of suitable comprehension using a series of prerecorded messages to wash their arms and hands prompting a performance response from the participant. It is also a perspective of the visual interpretation from a visual demonstration of that sequential step in the hygiene task of taking a bath from the animated video modeling which presents the physical responses that correspond to the verbal prompts of the hygiene task.

FIG. 5 is an illustration of a programming initiative instructing the participant with a specially crafted vocabulary of suitable comprehension using a series of prerecorded messages to wash their back prompting a performance response from the participant. It is also a perspective of the visual interpretation from a visual demonstration of that sequential step in the hygiene task of taking a bath from the animated video modeling which presents the physical responses that correspond to the verbal prompts of the hygiene task.

FIG. 6 is an illustration of a programming initiative instructing the participant with a specially crafted vocabulary of suitable comprehension using a series of prerecorded messages to wash their legs prompting a performance response from the participant. It is also a perspective of the visual interpretation from a visual demonstration of that sequential step in the hygiene task of taking a bath from the animated video modeling which presents the physical responses that correspond to the verbal prompts of the hygiene task.

FIG. 7 is an illustration of a programming initiative instructing the participant with a specially crafted vocabulary of suitable comprehension using a series of prerecorded messages to wash their feet prompting a performance response from the participant. It is also a perspective of the visual interpretation from a visual demonstration of that sequential step in the hygiene task of taking a bath from the animated video modeling which presents the physical responses that correspond to the verbal prompts of the hygiene task.

FIG. 8 is an illustration of a programming initiative instructing the participant with a specially crafted vocabulary of suitable comprehension using a series of prerecorded messages to rinse off completely and finish their bath prompting a performance response from the participant. It is also a perspective of the visual interpretation from a visual demonstration of that sequential step in the hygiene task of taking a bath from the animated video modeling which presents the physical responses that correspond to the verbal prompts of the hygiene task.

FIG. 9 is an illustration of a programming initiative instructing the participant with a specially crafted vocabulary of suitable comprehension using a series of prerecorded messages to turn on the water prompting a performance response from the participant. It is also a perspective of the visual interpretation from a visual demonstration of that sequential step in the hygiene task of taking a shower from the animated video modeling which presents the physical responses that correspond to the verbal prompts of the hygiene task.

FIG. 10 is an illustration of a programming initiative instructing the participant with a specially crafted vocabulary of suitable comprehension using a series of prerecorded messages to wash their face prompting a performance response from the participant. It is also a perspective of the visual interpretation from a visual demonstration of that sequential step in the hygiene task of taking a shower from the animated video modeling which presents the physical responses that correspond to the verbal prompts of the hygiene task.

FIG. 11 is an illustration of a programming initiative instructing the participant with a specially crafted vocabulary of suitable comprehension using a series of prerecorded messages to wash their hair prompting a performance response from the participant. It is also a perspective of the visual interpretation from a visual demonstration of that sequential step in the hygiene task of taking a shower from the animated video modeling which presents the physical responses that correspond to the verbal prompts of the hygiene task.

FIG. 12 is an illustration of a programming initiative instructing the participant with a specially crafted vocabulary of suitable comprehension using a series of prerecorded messages to wash their arms and hands prompting a performance response from the participant. It is also a perspective of the visual interpretation from a visual demonstration of that sequential step in the hygiene task of taking a shower from the animated video modeling which presents the physical responses that correspond to the verbal prompts of the hygiene task.

FIG. 13 is an illustration of a programming initiative instructing the participant with a specially crafted vocabulary of suitable comprehension using a series of prerecorded messages to wash their legs prompting a performance response from the participant. It is also a perspective of the visual interpretation from a visual demonstration of that sequential step in the hygiene task of taking a shower from the animated video modeling which presents the physical responses that correspond to the verbal prompts of the hygiene task.

FIG. 14 is an illustration of a programming initiative instructing the participant with a specially crafted vocabulary of suitable comprehension using a series of prerecorded messages to wash their feet prompting a performance response from the participant. It is also a perspective of the visual interpretation from a visual demonstration of that sequential step in the hygiene task of taking a shower from the animated video modeling which presents the physical responses that correspond to the verbal prompts of the hygiene task.

FIG. 15 is an illustration of a programming initiative instructing the participant with a specially crafted vocabulary of suitable comprehension using a series of prerecorded messages to rinse off in the shower prompting a performance response from the participant. It is also a perspective of the visual interpretation from a visual demonstration of that sequential step in the hygiene task of taking a shower from the animated video modeling which presents the physical responses that correspond to the verbal prompts of the hygiene task.

FIG. 16 is an illustration of a programming initiative instructing the participant with a specially crafted vocabulary of suitable comprehension using a series of prerecorded messages to turn off the water and finish their shower prompting a performance response from the participant. It is also a perspective of the visual interpretation from a visual demonstration of that sequential step in the hygiene task of taking a shower from the animated video modeling which presents the physical responses that correspond to the verbal prompts of the hygiene task.

FIG. 17 is an illustration of a programming initiative instructing the participant with a specially crafted vocabulary of suitable comprehension using a series of prerecorded messages to turn on the water prompting a performance response from the participant. It is also a perspective of the visual interpretation from a visual demonstration of that sequential step in the hygiene task of brushing their teeth from the animated video modeling which presents the physical responses that correspond to the verbal prompts of the hygiene task.

FIG. 18 is an illustration of a programming initiative instructing the participant with a specially crafted vocabulary of suitable comprehension using a series of prerecorded messages to put toothpaste on their toothbrush prompting a performance response from the participant. It is also a perspective of the visual interpretation from a visual demonstration of that sequential step in the hygiene task of brushing their teeth from the animated video modeling which presents the physical responses that correspond to the verbal prompts of the hygiene task.

FIG. 19 is an illustration of a programming initiative instructing the participant with a specially crafted vocabulary of suitable comprehension using a series of prerecorded messages to turn off the water prior to brushing prompting a performance response from the participant. It is also a perspective of the visual interpretation from a visual demonstration of that sequential step in the hygiene task of brushing their teeth from the animated video modeling which presents the physical responses that correspond to the verbal prompts of the hygiene task.

FIG. 20 is an illustration of a programming initiative instructing the participant with a specially crafted vocabulary of suitable comprehension using a series of prerecorded messages to brush their front teeth prompting a performance response from the participant. It is also a perspective of the visual interpretation from a visual demonstration of that sequential step in the hygiene task of brushing their teeth from the animated video modeling which presents the physical responses that correspond to the verbal prompts of the hygiene task.

FIG. 21 is an illustration of a programming initiative instructing the participant with a specially crafted vocabulary of suitable comprehension using a series of prerecorded messages to brush their side teeth prompting a performance response from the participant. It is also a perspective of the visual interpretation from a visual demonstration of that sequential step in the hygiene task of brushing their teeth from the animated video modeling which presents the physical responses that correspond to the verbal prompts of the hygiene task.

FIG. 22 is an illustration of a programming initiative instructing the participant with a specially crafted vocabulary of suitable comprehension using a series of prerecorded messages to brush the back side of their teeth prompting a performance response from the participant. It is also a perspective of the visual interpretation from a visual demonstration of that sequential step in the hygiene task of brushing their teeth from the animated video modeling which presents the physical responses that correspond to the verbal prompts of the hygiene task.

FIG. 23 is an illustration of a programming initiative instructing the participant with a specially crafted vocabulary of suitable comprehension using a series of prerecorded messages to fill a cup with water to rinse out their mouths prompting a performance response from the participant. It is also a perspective of the visual interpretation from a visual demonstration of that sequential step in the hygiene task of brushing their teeth from the animated video modeling which presents the physical responses that correspond to the verbal prompts of the hygiene task.

FIG. 24 is an illustration of a programming initiative instructing the participant with a specially crafted vocabulary of suitable comprehension using a series of prerecorded messages to turn off the water and finish brushing their teeth prompting a performance response from the participant. It is also a perspective of the visual interpretation from a visual demonstration of that sequential step in the hygiene task of brushing their teeth from the animated video modeling which presents the physical responses that correspond to the verbal prompts of the hygiene task.

FIG. 25 is an illustration of a programming initiative instructing the participant with a specially crafted vocabulary of suitable comprehension using a series of prerecorded messages to turn on the water prompting a performance response from the participant. It is also a perspective of the visual interpretation from a visual demonstration of that sequential step in the hygiene task of washing their hands from the animated video modeling which presents the physical responses that correspond to the verbal prompts of the hygiene task.

FIG. 26 is an illustration of a programming initiative instructing the participant with a specially crafted vocabulary of suitable comprehension using a series of prerecorded messages to get their hands wet prompting a performance response from the participant. It is also a perspective of the visual interpretation from a visual demonstration of that sequential step in the hygiene task of washing their hands from the animated video modeling which presents the physical responses that correspond to the verbal prompts of the hygiene task.

FIG. 27 is an illustration of a programming initiative instructing the participant with a specially crafted vocabulary of suitable comprehension using a series of prerecorded messages to get soap onto their hands prompting a performance response from the participant. It is also a perspective of the visual interpretation from a visual demonstration of that sequential step in the hygiene task of washing their hands from the animated video modeling which presents the physical responses that correspond to the verbal prompts of the hygiene task.

FIG. 28 is an illustration of a programming initiative instructing the participant with a specially crafted vocabulary of suitable comprehension using a series of prerecorded messages to scrub their hands by rubbing them together prompting a performance response from the participant. It is also a perspective of the visual interpretation from a visual demonstration of that sequential step in the hygiene task of washing their hands from the animated video modeling which presents the physical responses that correspond to the verbal prompts of the hygiene task.

FIG. 29 is an illustration of a programming initiative instructing the participant with a specially crafted vocabulary of suitable comprehension using a series of prerecorded messages to rinse the soap off of their hands prompting a performance response from the participant. It is also a perspective of the visual interpretation from a visual demonstration of that sequential step in the hygiene task of washing their hands from the animated video modeling which presents the physical responses that correspond to the verbal prompts of the hygiene task.

FIG. 30 is an illustration of a programming initiative instructing the participant with a specially crafted vocabulary of suitable comprehension using a series of prerecorded messages to turn off the water and dry their hands prompting a performance response from the participant. It is also a perspective of the visual interpretation from a visual demonstration of that sequential step in the hygiene task of washing their hands from the animated video modeling which presents the physical responses that correspond to the verbal prompts of the hygiene task.

FIG. 31 is an illustration of a programming initiative instructing the participant with a specially crafted vocabulary of suitable comprehension using a series of prerecorded messages to put their napkin on their lap prompting a performance response from the participant. It is also a perspective of the visual interpretation from a visual demonstration of that sequential step in the hygiene associated task of basic table manners from the animated video modeling which presents the physical responses that correspond to the verbal prompts of the hygiene task.

FIG. 32 is an illustration of a programming initiative instructing the participant with a specially crafted vocabulary of suitable comprehension using a series of prerecorded messages to use their fork and knife to cut a small piece of food prompting a performance response from the participant. It is also a perspective of the visual interpretation from a visual demonstration of that sequential step in the hygiene associated task of basic table manners from the animated video modeling which presents the physical responses that correspond to the verbal prompts of the hygiene task.

FIG. 33 is an illustration of a programming initiative instructing the participant with a specially crafted vocabulary of suitable comprehension using a series of prerecorded messages to use their fork and place the small piece of food into their mouth prompting a performance response from the participant. It is also a perspective of the visual interpretation from a visual demonstration of that sequential step in the hygiene associated task of basic table manners from the animated video modeling which presents the physical responses that correspond to the verbal prompts of the hygiene task.

FIG. 34 is an illustration of a programming initiative instructing the participant with a specially crafted vocabulary of suitable comprehension using a series of prerecorded messages to chew their food thoroughly before swallowing prompting a performance response from the participant. It is also a perspective of the visual interpretation from a visual demonstration of that sequential step in the hygiene associated task of basic table manners from the animated video modeling which presents the physical responses that correspond to the verbal prompts of the hygiene task.

FIG. 35 is an illustration of a programming initiative instructing the participant with a specially crafted vocabulary of suitable comprehension using a series of prerecorded messages to not chew their food with their mouth open prompting a performance response from the participant. It is also a perspective of the visual interpretation from a visual demonstration of that sequential step in the hygiene associated task of basic table manners from the animated video modeling which presents the physical responses that correspond to the verbal prompts of the hygiene task.

FIG. 36 is an illustration of a programming initiative instructing the participant with a specially crafted vocabulary of suitable comprehension using a series of prerecorded messages to not talk with food in their mouth prompting a performance response from the participant. It is also a perspective of the visual interpretation from a visual demonstration of that sequential step in the hygiene associated task of basic table manners from the animated video modeling which presents the physical responses that correspond to the verbal prompts of the hygiene task.

FIG. 37 is an illustration of a programming initiative instructing the participant with a specially crafted vocabulary of suitable comprehension using a series of prerecorded messages for a step by step process to make their bed prompting a performance response from the participant. It is also a perspective of the visual interpretation from a visual demonstration of that sequential step in the hygiene associated task of a morning grooming routine from the animated video modeling which presents the physical responses that correspond to the verbal prompts of the hygiene task.

FIG. 38 is an illustration of a programming initiative instructing the participant with a specially crafted vocabulary of suitable comprehension using a series of prerecorded messages for a step by step process to dress themselves prompting a performance response from the participant. It is also a perspective of the visual interpretation from a visual demonstration of that sequential step in the hygiene associated task of a morning grooming routine from the animated video modeling which presents the physical responses that correspond to the verbal prompts of the hygiene task.

FIG. 39 is an illustration of a programming initiative instructing the participant with a specially crafted vocabulary of suitable comprehension using a series of prerecorded messages for a step by step process to put their dirty clothing in the proper place prompting a performance response from the participant. It is also a perspective of the visual interpretation from a visual demonstration of that sequential step in the hygiene associated task of a morning grooming routine from the animated video modeling which presents the physical responses that correspond to the verbal prompts of the hygiene task.

FIG. 40 is an illustration of a programming initiative instructing the participant with a specially crafted vocabulary of suitable comprehension using a series of prerecorded messages for a step by step process to wash their face prompting a performance response from the participant. It is also a perspective of the visual interpretation from a visual demonstration of that sequential step in the hygiene associated task of a morning grooming routine from the animated video modeling which presents the physical responses that correspond to the verbal prompts of the hygiene task.

FIG. 41 is an illustration of a programming initiative instructing the participant with a specially crafted vocabulary of suitable comprehension using a series of prerecorded messages for a step by step process to brush their teeth prompting a performance response from the participant. It is also a perspective of the visual interpretation from a visual demonstration of that sequential step in the hygiene associated task of a morning grooming routine from the animated video modeling which presents the physical responses that correspond to the verbal prompts of the hygiene task.

FIG. 42 is an illustration of a programming initiative instructing the participant with a specially crafted vocabulary of suitable comprehension using a series of prerecorded messages for a step by step process to comb or brush their hair prompting a performance response from the participant. It is also a perspective of the visual interpretation from a visual demonstration of that sequential step in the hygiene associated task of a morning grooming routine from the animated video modeling which presents the physical responses that correspond to the verbal prompts of the hygiene task.

### BRIEF DESCRIPTION OF THE PREFERRED EMBODIMENT

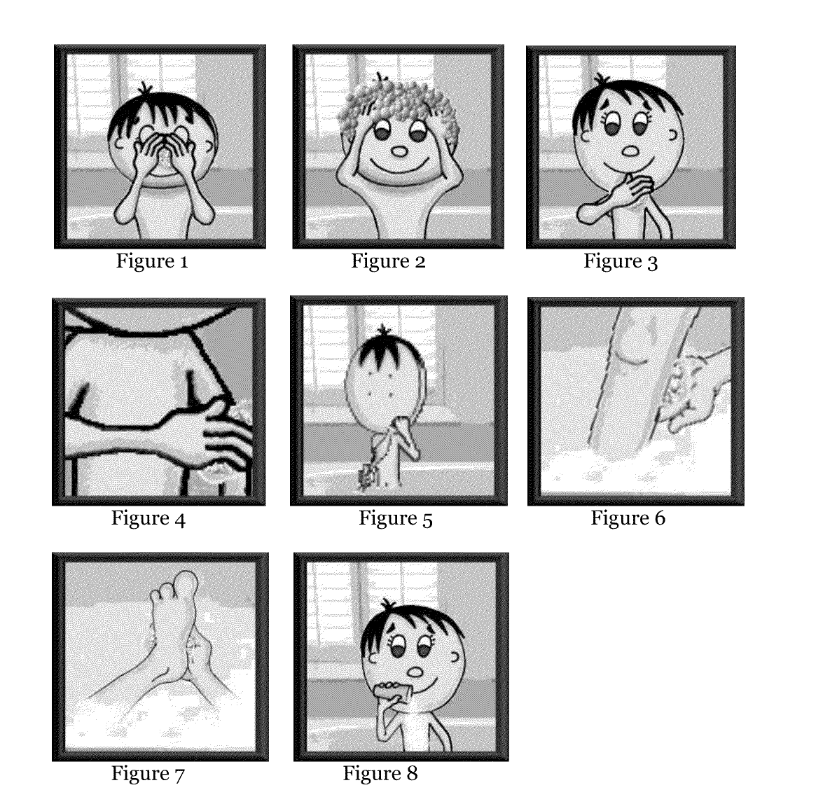

In the preceding discussion of the inability of the prior art and available products to address the specific needs, issues and challenges concerning the effective instruction and teaching of hygiene tasks to developmentally disabled individuals, this present invention fills that void by providing a system and method that is intentionally constructed for efficacious application to participants with compromised reasoning and cognitive ability. This is accomplished by providing the participants with prerecorded directions for playback on CD or a device with similar capabilities. This embodiment provides for an adult caregiver of reasonable skill to place the playback device in a safe proximity to the participant and start the playback of the prerecorded messages. The playback begins with the start of the hygiene task. The directions are presented in a very primary fashion with terms and expressions of simple structure for ease of understanding and allows for sufficient time for someone of compromised comprehension to perform the task. Each direction is repeated numerous times, using the identical words in the precise order with each repetition of command so as not to confuse the participant. The instructions proceed in a sequential order as would be necessary to complete the specific hygiene task as in FIG. 1 it can be seen from the illustration that the verbal prompts at this stage of the task is asking the participant to wash their face. The instructions include the description of raising the wash cloth to their face, closing their eyes and lightly moving the wet wash cloth over the entire area of their face. The instructions are given in great detail using easily understandable phrases and repeated numerous times for each segment of each step of the process to wash their face. This type of redundant structure is used throughout the entire program. In FIG. 2 it is illustrated that the verbal prompts are at the point where it is time for the participant to wash their hair. This again is broken down into painstaking detail and repeated often to allow a developmentally disabled participant to perform this phase of the task without a tremendous amount of assistance. In the preferred embodiment it is recommended that the caregiver always monitor the participant as these individuals should not try to perform these tasks without supervision. The framework of these prerecorded messages is to facilitate better performance by the participants not replace the supervision that is needed with this class of participant. In FIG. 3 the participant is instructed to wash their neck, chest and shoulders. As in the preceding steps this step is broken down into small incremental segments, each being explained in easily understood terms and phrases and each being repeated throughout the time frame needed for the participants to complete the incremental segment. In FIG. 4 the participant is instructed to wash their hands and arms as they continue to perform within a predictable range of acceptable performance based on the primary descriptive features of the prerecorded messages. In FIG. 5 the participant is instructed to wash their back, which requires a more complex series of instruction and therefore more time to complete and each segment broken down into more easily managed micro-segments that facilitate the continued ease of use with the program. This type of training and teaching by means of incremental and comprehensive step-by-step tutorial directions, dedicated and designed for individuals with special needs continues throughout the entire process of taking a bath as illustrated in FIG. 6 where the participant is instructed to wash their legs.

Again, the instruction is offered repeatedly in language and phrasing specifically selected to facilitate the understanding of compromised cognition. In FIG. 7 the participant is instructed to wash their feet using this unique approach that doesn't intend to adapt or modify any program that may be used by a “normal” participant who will out-pace and progress beyond the scope of a program like this extremely rapidly. In FIG. 8 the participant is guided and instructed through the final steps of taking bath including rinsing as shown in the illustration. The instructions conclude with the final series of directions prior to a caregiver assisting the participant out of the bath tub. As shown in FIGS. 1 through 42, the focus of this system is on the activities of daily living that constitute a significant challenge to both an individual with special needs and the caregivers. There are 6 tasks that are the core of this instructional series which include; washing hands; brushing teeth; taking a bath; taking a shower; basic table manners; and a morning grooming routine.

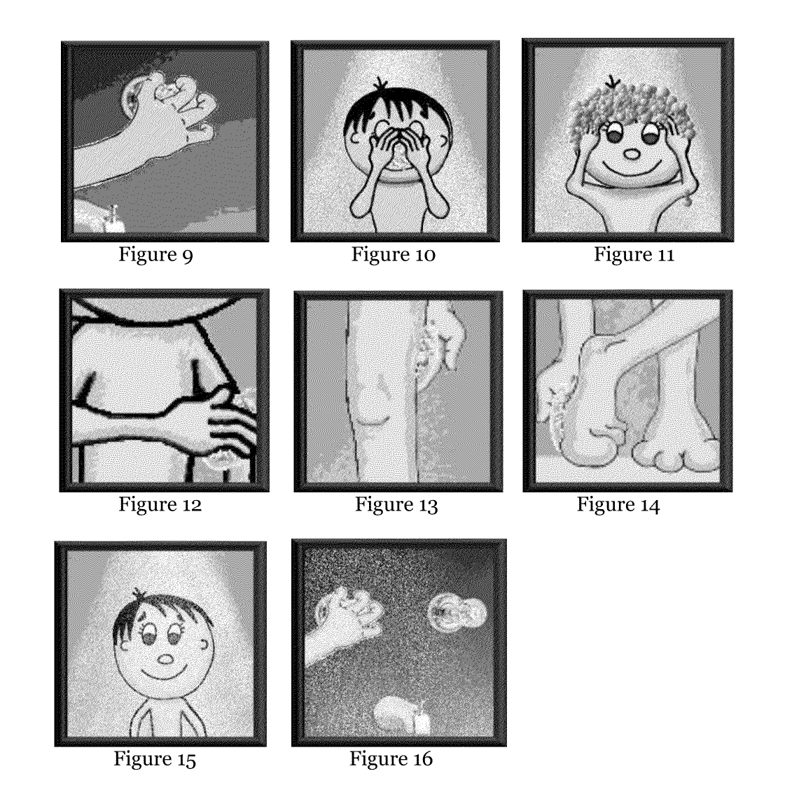

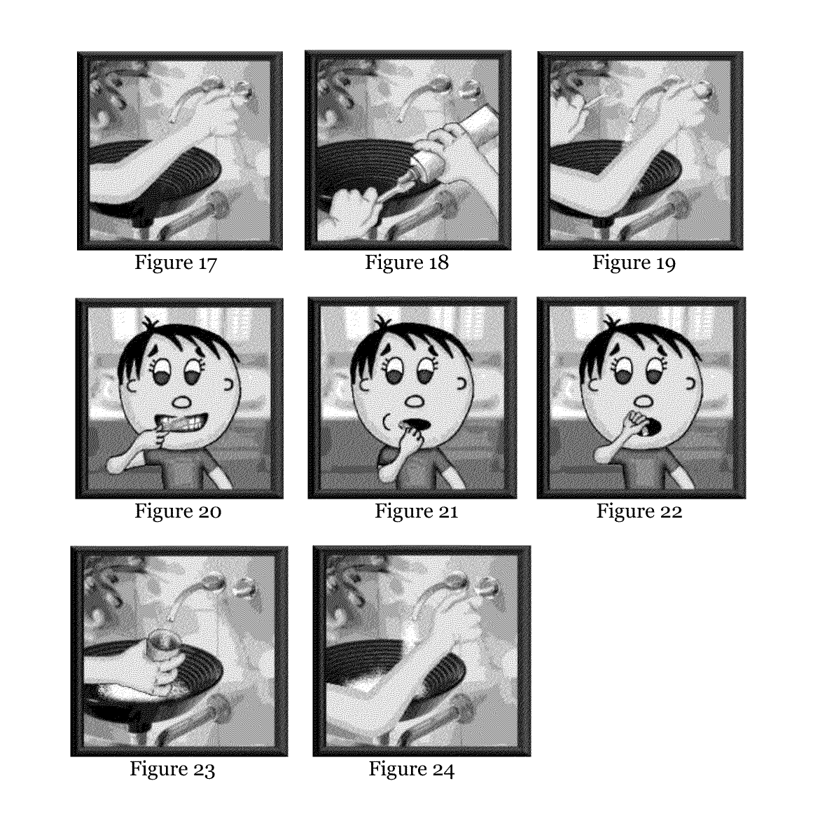

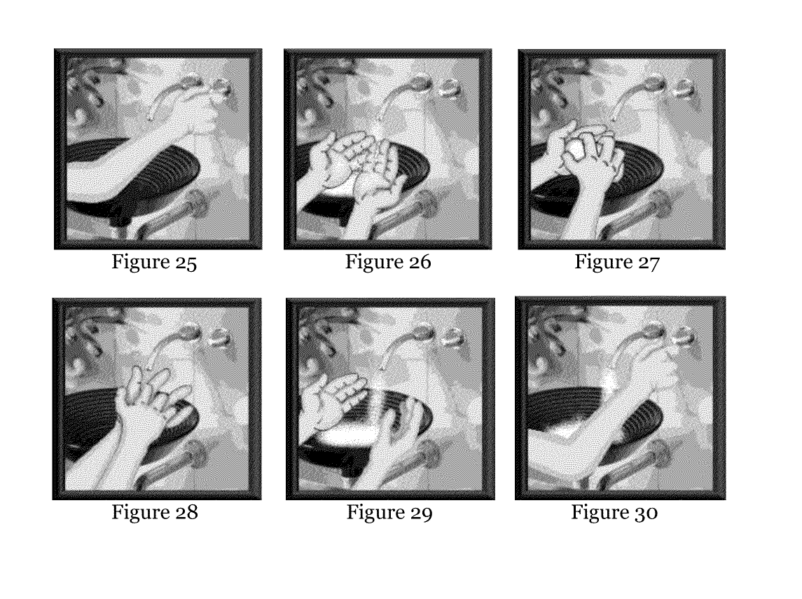

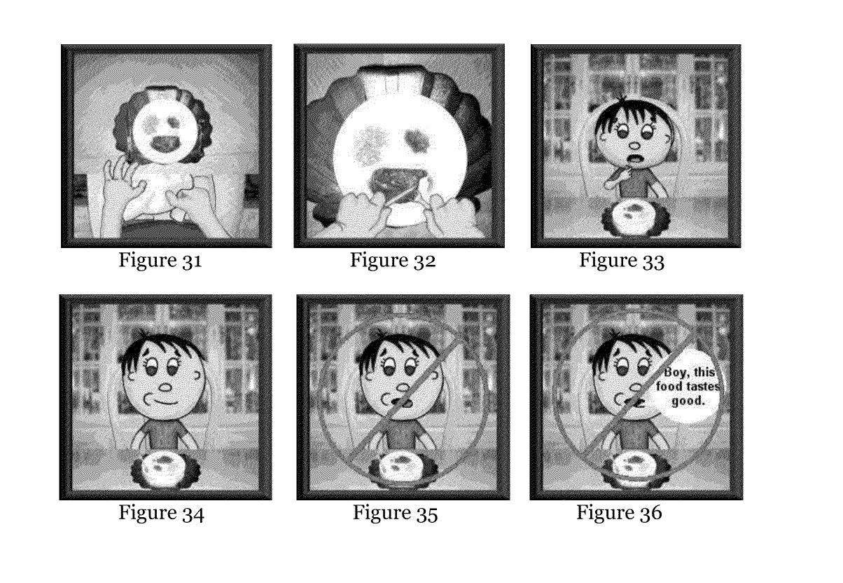

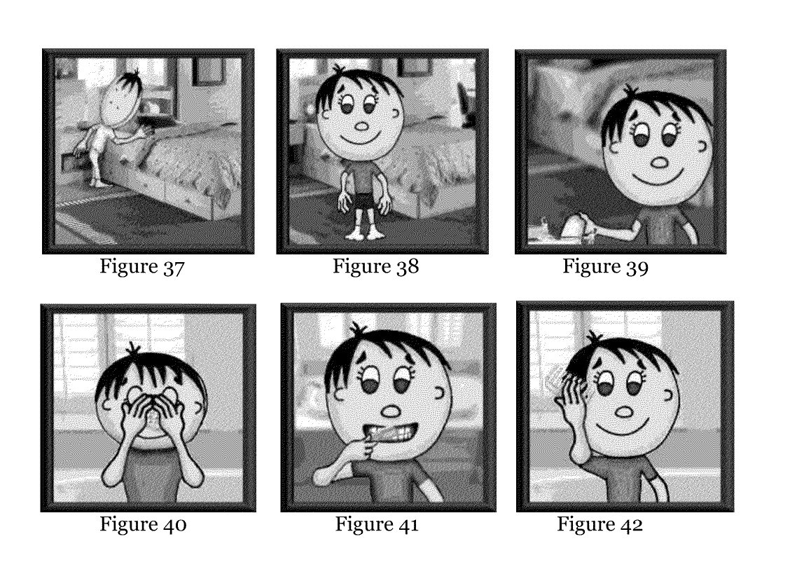

Within the preferred embodiment is the use of the companion animated video modeling component which is used in conjunction with the verbal prompts of the prerecorded messages. This offers the participant the opportunity to watch an animated character through an actual performance of the hygiene tasks which demonstrates a range of acceptable and anticipated physical response to the directions from the actual hygiene recorded tutorials. Selected frames from the animated video modeling component are shown in FIGS. 1-42. The particular breakdown of tasks within the included illustrations are as follows: FIGS. 1-8 have been selected from the animated video model illustrating and instructing the range of physical responses for the prerecorded directions for taking a bath. FIGS. 9-16 have been selected from the animated video model illustrating and instructing the range of physical responses for the prerecorded directions for taking a shower. FIGS. 17-24 have been selected from the animated video model illustrating and instructing the range of physical responses for the prerecorded directions for brushing teeth. FIGS. 25-30 have been selected from the animated video model illustrating and instructing the range of physical responses for the prerecorded directions for washing hands. FIGS. 31-36 have been selected from the animated video model illustrating and instructing the range of physical responses for the prerecorded directions for basic table manners. FIGS. 37-42 have been selected from the animated video model illustrating and instructing the range of physical responses for the prerecorded directions for a morning grooming routine.

### Example

The following example constitutes this particular preferred embodiment, the problems that exist within the current structure utilized for the activities of daily living within special populations and how this system and method addresses that need.

This is the story of a young woman in her early twenties chronologically, but only five or six developmentally. Sarah was born without any sign of a disability but suffered a brain injury before reaching the age of 3. She was eventually placed under the care of her grandmother who provided a loving home and raised her. Sarah attended special education classes in the local public schools and upon graduation moved into a County assisted living facility. Sadly, this was disastrous as Sarah's functioning capability allowed her to be taken advantage of by others. When this was discovered she was moved into a Group Home for developmentally disabled adults.

Sarah, like so many others with a developmental disability has a difficult time understanding and following directions with an even harder time remembering them. This is extremely evident when trying to accomplish the activities of daily living that are taken for granted in society. In Sarah's case, she would use soap when washing her hands, but let the water wash it away before scrubbing them every time she needed to wash her hands. Brushing her teeth was much the same, she would put toothpaste on her brush but all too often she would rinse off the toothpaste before starting to brush her teeth and if unmonitored, she would simply brush her front teeth never bothering to do the backs or sides. This was much the same in the shower in spite of her grandmother working with her each time she showered for over 18 years, Sarah still washed the same way, merely rubbing her stomach over and over thinking this was all that was needed when taking a shower.

Due to Sarah's inability to wash her hands correctly she gets sick nearly every month due to the habit of putting her unwashed fingers into her mouth. In many instances this requires a visit to the doctor for medication. The lack of proper dental care at this point has only resulted in cavities and numerous warnings about gum disease, but that same inability to brush properly may eventually need to be addressed with dentures. Finally the poor showering habits have contributed to several urinary track infections again requiring medication and repeated trips to the doctor's office. The one common factor in each of these activities, the poor hand washing, teeth brushing, and showering is that the problems that resulted from the poor performance were all preventable.

One thing that must occur for any breakthrough with performance among special needs is that there must be continuity in the expression of any instructions that you want the individual to execute. For example; if you issued the instruction to:

1. turn off the light

2. make out the light

3. turn the light off

4. hit the light switch

5. put out the light

You would probably recognize this as five different ways of expressing the same task. To someone with a developmental disability this represents five different tasks. If you expect them to understand and execute the physical response to that directive and turn off the light, you must be very precise each and every time you issue the instruction and further, they must know exactly what range of acceptable physical response is expected of them when they hear that instruction. That would entail each time that you want them to turn off the light, you ask them to “turn off the light”. This also presupposes that you have repeatedly demonstrated to them what you mean when you issue that instruction.

This becomes even more complicated when you involve two or three different caregivers trying to teach a task. You may have one caregiver saying to “put out the light” while another is saying to “turn off the light”. This confusion is compounded when it is repeated for a number of years with even more caregivers coming and going and offering their own directions for a single task. That exemplifies one of the greatest attributes of this method which is to present the participant with the exact same instructions with the exact same words every time they perform the hygiene task. That type of redundant, consistent instruction has a tremendous impact on the ability of the participants to understand and recognize the instructions.

Sarah would start to utilize this system and method by watching the animated video modeling which consists of an illustrated cartoon character that demonstrates each of the hygiene tasks using the actual verbal prompts from the audio prerecorded messages. This component allows a participant to repeatedly watch the program to acclimate themselves to the anticipated range of physical responses to the verbal prompts of the audio component. Sarah would then be able to utilize the prerecorded messages while performing the actual hygiene task as in the case of washing her hands. Her caregiver would start the instructions on CD or similar device and the hand washing instruction would begin by directing the participant to turn on the water and how to ensure that it isn't too hot. It continues by issuing each instruction on effective hand washing from the initial stage of getting the hands wet followed by the application of soap and the actual scrubbing of the hands. It concludes with the instructions to rinse off the soap, turning off the water and drying off the hands. The pauses between each direction have been predetermined to accommodate an individual with special needs and are optimized to ensure that there is enough time between directions for the individual to properly perform the task. This type of optimization of each hygiene task with attention to detail and the utilization of language and programming needs to fit a participant with developmental disabilities has been conducted and accomplished with each of the activities of daily living that constitutes this present invention.

1. A personal hygiene system and method using pre-recorded messages with specially crafted vocabulary of appropriate comprehension in combination with animated video modeling that presents a visual interpretation from a visual demonstration of the sequential steps of the system that shows the physical response range that corresponds to the verbal prompts for these hygiene tasks specifically designed for developmentally disabled individuals in which:
The language used is selected and utilized at an appropriate level of understanding for individuals challenged developmentally.
Each hygiene task is presented in an extremely primary and fundamental fashion designed for a participant who will not remember or retain instructions; not be able to nor learn to anticipate directions; not be able to nor is expected to progress or advance in reasoning or problem solving ability;
not able to nor is expected to progress in proficiency or performance capability.
Specific hygiene tasks are addressed in a strategic sequential manner that steers, conducts and guides a participant from start to finish in a very basic, primary yet comprehensive fashion at an appropriate level of understanding for a developmentally disabled participant.
The prerecorded messages and animated video modeling addresses the following hygiene and hygiene related tasks; taking a bath; taking a shower; brushing your teeth; washing your hands; basic table manners; and a morning grooming routine.

2. A personal hygiene system and method using an animated video modeling component that presents a visual demonstration of the physical response range that corresponds to the verbal prompts of prerecorded audio messages that:
Provides an animated character that demonstrates the physical responses expected from the verbal prompts of each hygiene task
Provides an animated presentation that demonstrates an operational range of functioning for each sequential phase of the tasks which enables a developmentally disabled participant to successfully accomplish the task.
